(19) United States
(12) Patent Application Publication
(10) Pub. No.: US 2016/0206413 A1
(43) Pub. Date: Jul. 21, 2016

(54) TOOTHBRUSH ELEMENT

(71) Applicant: RUPRECHT-KARLS-UNIVERSITAET

(72) Inventors: Hannes KAPPEL, Heidelberg (DE); Stefanie KAPPEL, Heidelberg (DE)

(21) Appl. No.: 14/912,829

(22) PCT Filed: Aug. 6, 2014
(86) PCT No.: PCT/EP2014/066923

§ 371 Date: Feb. 18, 2016

(30) Foreign Application Priority Data
Aug. 19, 2013 (DE) 10 2013 108 935

(51) Int. Cl. A61C 17/22; A46B 9/04

(52) U.S. Cl. CPC A61C 17/222; A46B 9/04

(57) ABSTRACT

A toothbrush element (1), comprising a head (3) furnished with bristles (2), wherein the bristles (2) are arranged in a ring shape on the head (3), so that the bristles (2) surround a recess (4), and also an electric toothbrush with the toothbrush element.

The invention relates to a toothbrush element comprising a head furnished with bristles.

Dental calculus, which is also known as plaque, is the main cause for gingivitis. It is known that such inflammation leads to the destruction of the pariodontal apparatus and can thus promote the development of periodontitis. With dental implants, this condition is manifested in the form of periimplantitis. Both diseases can result in the loss of teeth or implants.

Proper care of teeth and/or implants is thus essential for their long-term preservation. Electric toothbrushes contribute toward a definite improvement in oral hygiene. An electric toothbrush consists of an operating part with a handle that accommodates a battery and an electric motor. The operating part is provided with an adaptor for replaceable accommodation of a toothbrush element. The toothbrush element is attached to the operating part before beginning to clean the teeth. The toothbrush element has a shaft and a head, the latter of which is furnished with bristles and can be made to rotate or oscillate. This in turn induces an oscillating rotational movement in the bristles, or the bristles transmit high-frequency oscillations. The principle mentioned last is used with a sonic or ultrasonic toothbrush. The toothbrush element is attached to the operating part by means of the shaft.

With electric toothbrushes, for example, such as those known from EP 1 626 674 B1, the head often has a circular design and is furnished with bristles arranged in the form of a pattern on the head. In most cases, one portion of the bristles is arranged around the outer circumference of the head in the form of a ring, while a second portion of the bristles is arranged centrally at the center of head and a third portion of the bristles is arranged according to a predetermined pattern between the inner bristles and the outer bristles. The head is attached to the shaft in a rotationally movable manner and is connected to the operating part in such a way that movements are transferred from the operating part to the head.

Teeth or implants that have been treated with a removable denture, for example, double crowns or implants with form-fitting/force-locking connecting elements definitely have a shape different than that of natural teeth. They have a smaller diameter and there are larger interspaces with the neighboring teeth. The disadvantage here is that these interspaces cannot be reached and cleaned adequately using the previous toothbrush element. Toothbrush elements known in the past mainly clean areas that are far away from the areas of the gingival area that is sensitive to plaque. Furthermore, areas at the back of the mouth are less accessible. This is true in particular of the elderly, who have various motor restrictions.

Against the background of these problems, the object of the present invention is to improve upon the cleaning effect on teeth, teeth treated with dentures and implants with dentures, in particular free-standing teeth and implants.

This object is achieved with the features of claim 1. The dependent claims describe advantageous embodiments.

To solve this problem, the bristles are arranged in a ring pattern on the head in such a way that the bristles surround a recess. In this design, there is an exclusively ring-shaped arrangement of the bristles, such that the space surrounded by the bristles arranged in a ring pattern at the center of the head is free of bristles. This therefore results in a recess at the center of the head, into which the tooth and/or the tooth treated with a denture or the dental implant may extend. It is advantageous that the bristles surround the tooth, the implant or the denture on the circumference and that the bristle head is centered on the tooth or the denture. It is therefore also possible for the bristles to reach deeper regions of the tooth or the implant and therefore be able to also clean deeper regions of the tooth, the implant or the denture at the transition to the gingiva. Plaque occurring in this location can therefore be removed reliably and the development of gingivitis can be prevented. The ring-shaped arrangement of bristles in the sense of the invention is therefore understood to be either a circular arrangement of bristles or an oval arrangement of bristles.

The head may be provided with an indentation, which is allocated to the recess. The indentation is advantageous in particular when the tooth or denture to be cleaned is so long that it cannot be accommodated completely in the space formed by the recess. In this case, the bristles do not reach the region at the transition to the gingiva, so this region cannot be cleaned optimally. Thanks to the indentation, the tooth or the denture can also protrude into the head, so that even the base of longer teeth or longer dentures can be cleaned.

The head may have a passage in the region of the recess. With this design, the head has an annular design, so that the tooth or the denture can protrude through the head. The bristles are arranged on the circumference of the head, which is designed as a ring, with the bristles thus surrounding the recess. With this design, optimal cleaning of all regions of teeth or dentures that are particularly long is possible. In addition, it is advantageous that the bristles can be cleaned especially effectively after conclusion of the tooth cleaning, because water can reach the bristles through the passage by way of the free ends of the bristles and also by way of the head. An annular design of the head in the sense of the invention is to be understood as including both circular and oval designs of the head.

In an alternative embodiment, the passage is designed so that the head has the shape of a partial circle, for example, a semicircle. The toothbrush element can therefore be guided to the location to be cleaned in a particularly simple manner.

The bristles may be inclined toward one another. In this design, the bristles protrude into the space formed by the recess. The bristles therefore have a conical configuration on the whole, such that the diameter of the annular arrangement of bristles is larger in the connecting region to the head than at the free ends of the bristles. In the case of bristles that are inclined toward one another, it is advantageous that they are always in contact with the tooth, the implant and/or the tooth treated with a denture that is to be cleaned, such that the head is centered automatically during the cleaning operation, so that the tooth, the implant and/or the denture can be reached as well over the entire perimeter. In addition, this yields a particularly good cleaning effect at the base of the tooth, the implant and/or the denture at the transition to the gingiva because the diameter of the tooth, the implant or the denture is usually the greatest in this region, and therefore the contact pressure of the bristles with the tooth, the implant or the denture is the greatest.

In an advantageous embodiment, the bristles are arranged obliquely on the head. It is therefore possible to attach straight bristles, which are therefore inexpensive to manufacture, to the head and to do so in such a way that they are inclined toward one another.

In an alternative embodiment, the bristles may be designed with a curve and/or a kink. Such bristles may be arranged in a straight alignment on the head, but due to the curved and/or kinked design of the bristles, they are nevertheless inclined toward one another at the free ends, so that an increased cleaning effect is achieved in the region of the tips of the bristles. However, it is also conceivable to arrange curved and/or kinked bristles obliquely on the head.

Furthermore, it is conceivable for the bristles to be disposed in sections in a ring pattern on the head, so that first sections are arranged obliquely on the head and second sections are arranged in a straight pattern on the head.

In an alternative embodiment, the head of the toothbrush element is designed in the form of a partial ring circle. The passage therefore extends through the head on the side facing away from the shaft, and the toothbrush element can be guided laterally up to the tooth or the implant to be cleaned. Again in this embodiment, the passage and the head may have an oval design.

The toothbrush element is preferably designed as an attachment for an electric toothbrush. Because of the annular arrangement of the bristles on the head, it is advantageous, if the bristles either oscillate, i.e., move back and forth on a circular path, or if they transmit high-frequency vibrations in the form of sound waves or ultrasonic waves. It is difficult to achieve such a tooth-cleaning motion, which can be achieved only inadequately with a manual toothbrush, so that the bristle arrangement according to the invention is preferably used with an electric toothbrush to which the toothbrush element is attached as an attachment to an electric toothbrush, and then after the toothbrush is turned on, the bristles are either made to execute an oscillating movement or the bristles transmit high-frequency sound waves. The toothbrush element according to the invention is designed as a disposable part, which is replaced by a new one for hygienic reasons after a certain period of use.

A electric toothbrush according to the invention comprises an operating part with a handle and a toothbrush element with a head furnished with bristles, such that the bristles are arranged in a ring on the head, so that the bristles surround a recess.

The operating part is preferably designed as a cylinder and accommodates a battery or some other energy storage mechanism and an electric motor and/or an element for generating high-frequency sound waves. In addition, the operating part has an adaptor to which the shaft of the toothbrush element can be attached. The toothbrush element here can be attached in this way so that either the head with the bristles can be made to execute an oscillating movement or the sound waves or ultrasonic waves created in the operating part can be transmitted to the bristles.

A few embodiments of the toothbrush element according to the invention and the electric toothbrushes according to the invention will be explained in greater detail below with reference to the figures, which show, each in schematic diagrams:

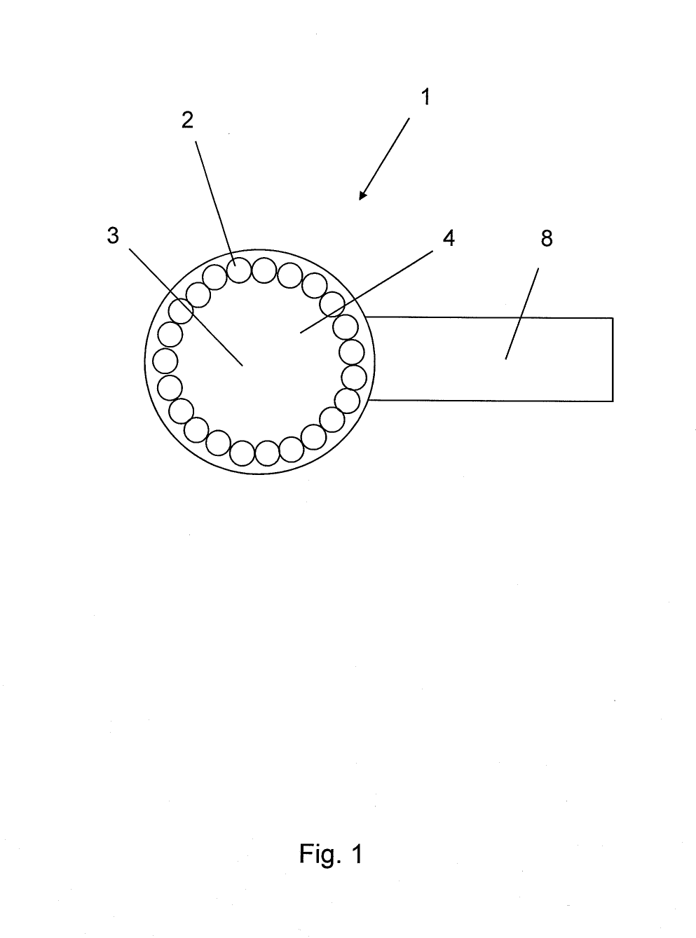

FIG. 1 a toothbrush element as seen from below;

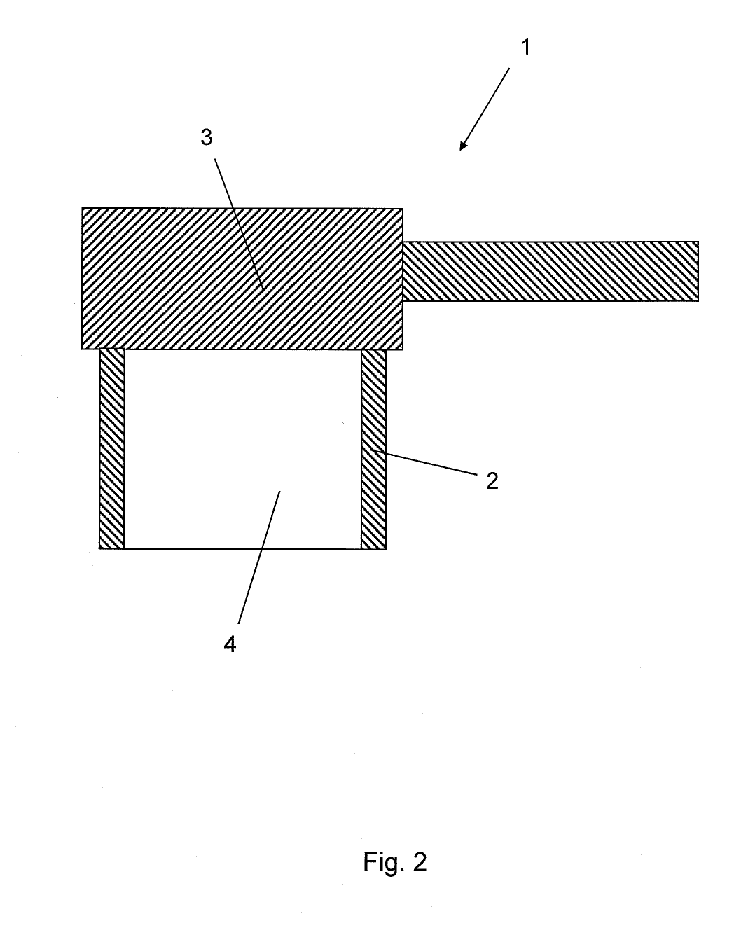

FIG. 2 a toothbrush element in a sectional diagram from the side;

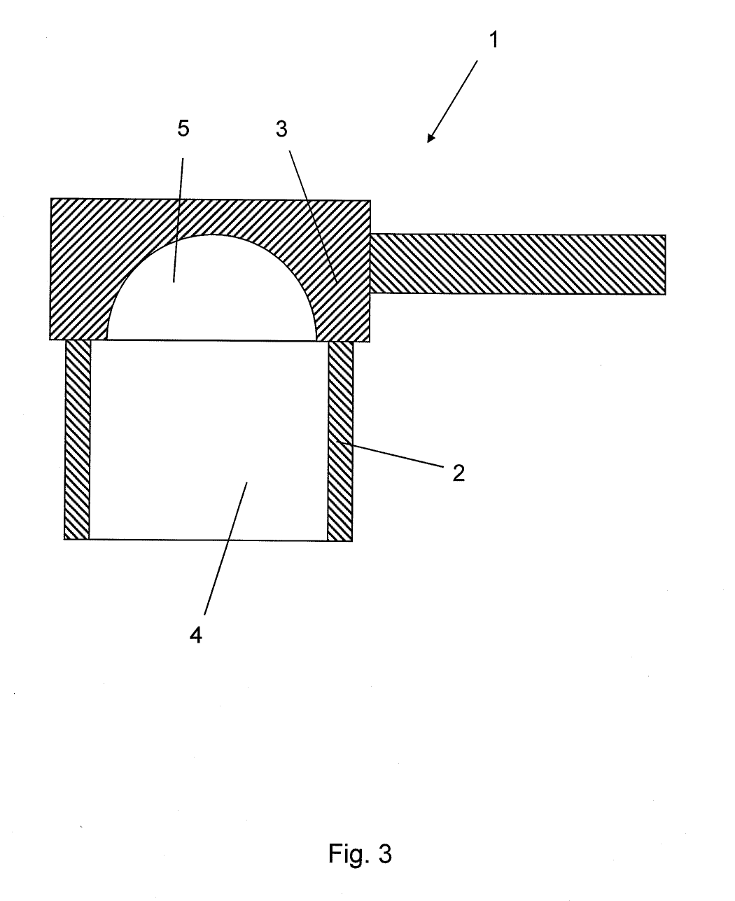

FIG. 3 a toothbrush element with an indentation;

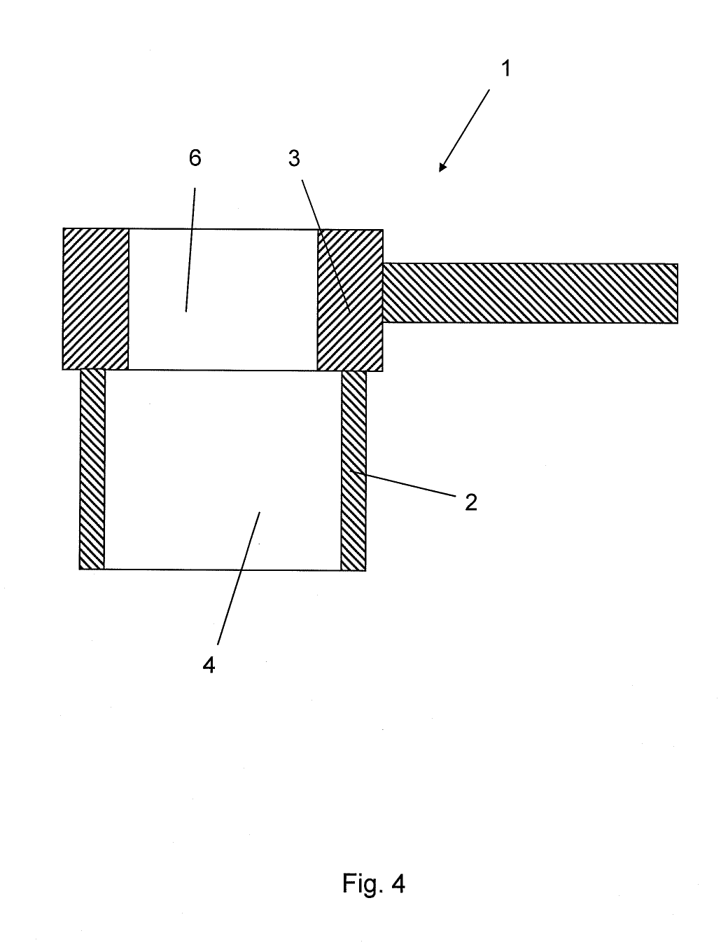

FIG. 4 a toothbrush element with a passage;

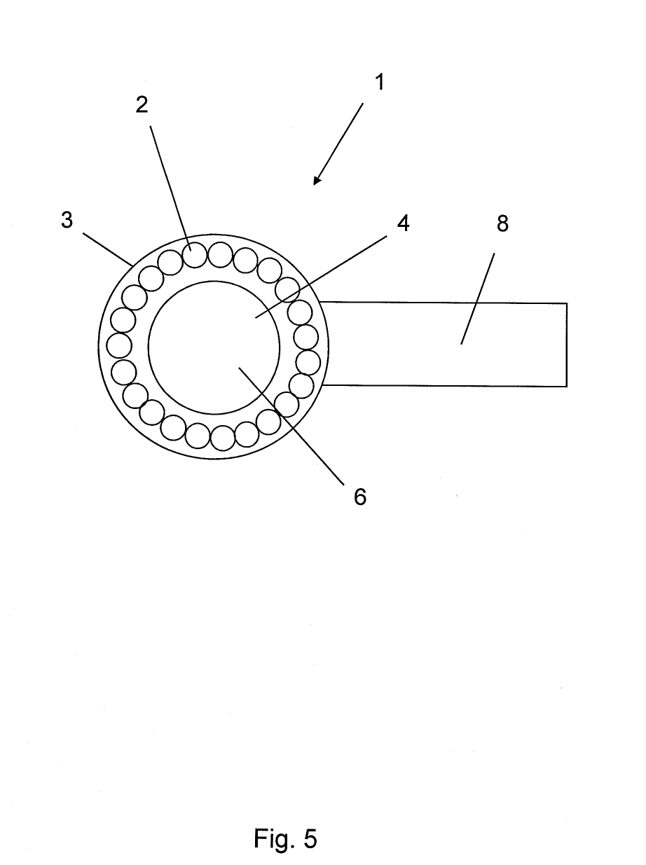

FIG. 5 a toothbrush element according to FIG. 4 as seen from below;

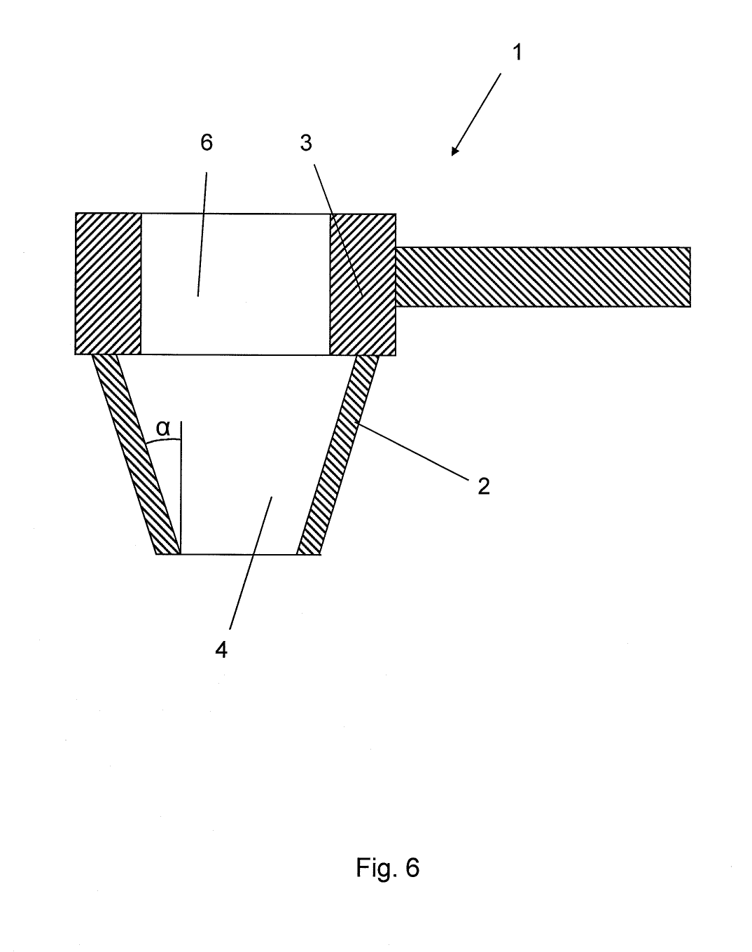

FIG. 6 a toothbrush element with bristles arranged at an inclination;

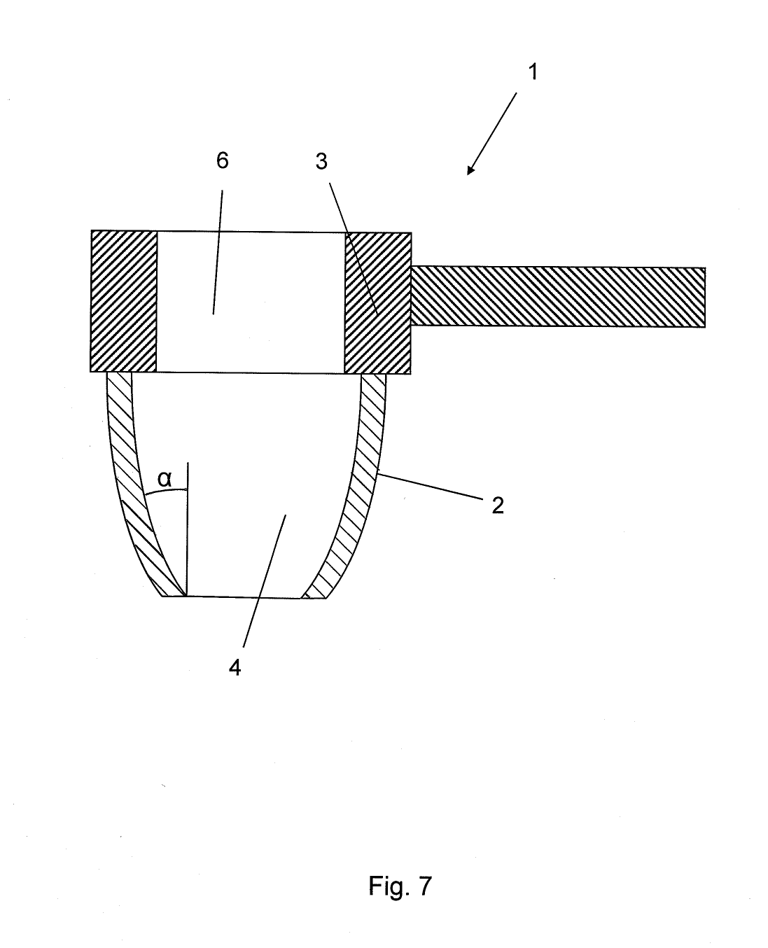

FIG. 7 a toothbrush element with curved bristles;

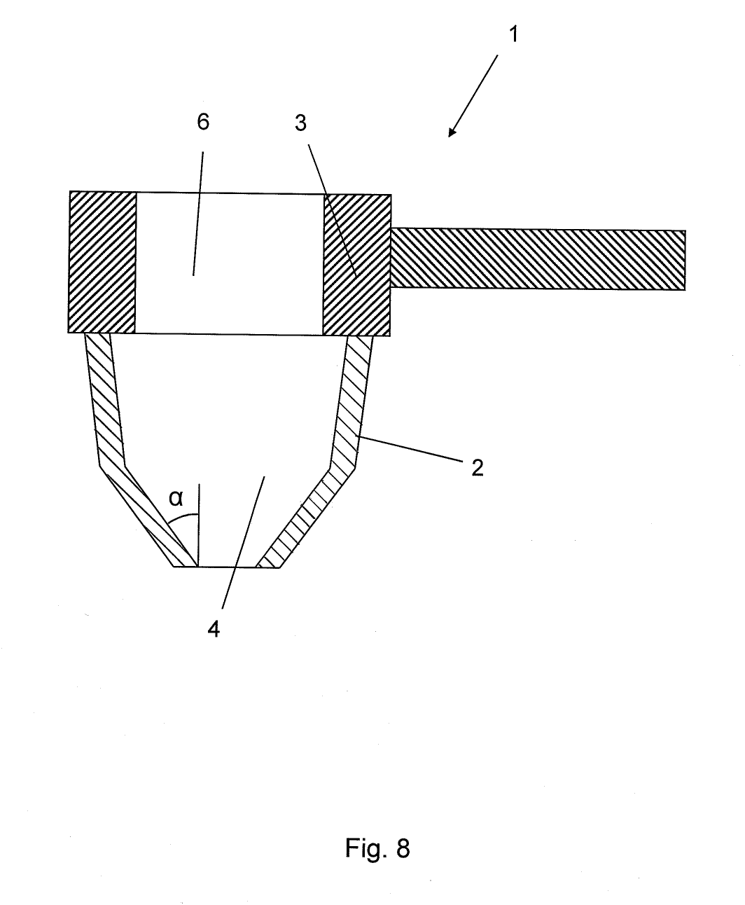

FIG. 8 a toothbrush element with kinked bristles;

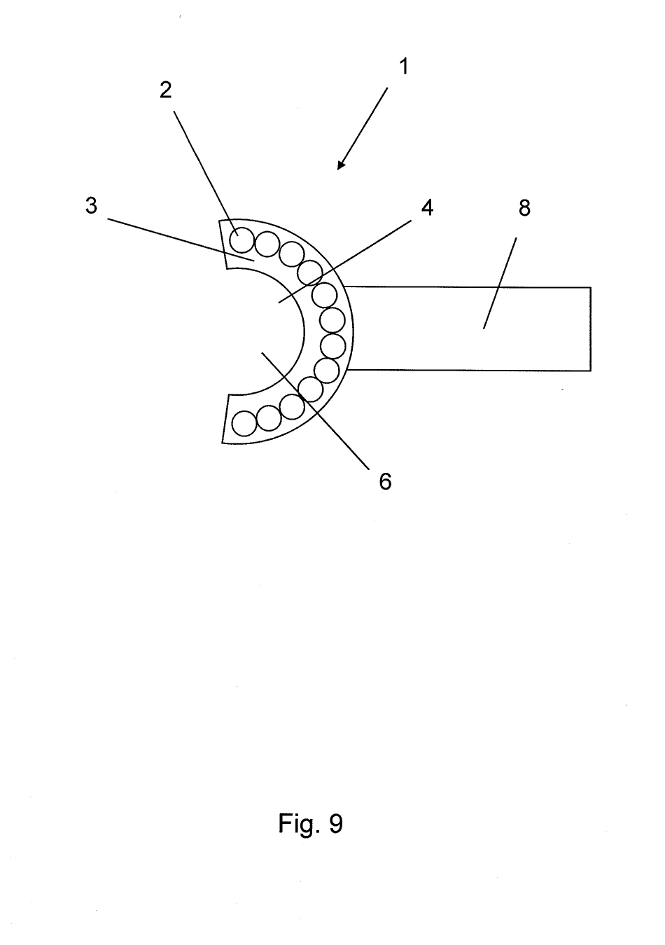

FIG. 9 with a partially circular head;

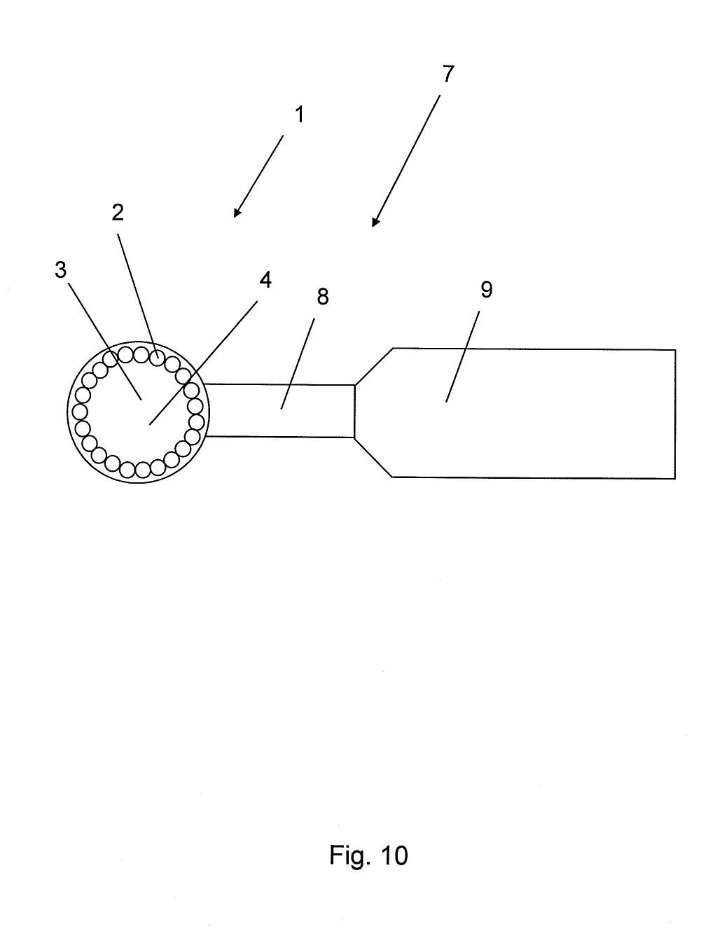

FIG. 10 an electric toothbrush.

FIG. 1 shows in a view from beneath a toothbrush element 1 with a head 3, to which bristles 2 are attached. The head 3 is in turn arranged on a shaft 8.

The toothbrush element 1 is preferably designed as an attachment for an electric toothbrush 7. In this case, the shaft 8 forms the fastening element for fastening the toothbrush element 1 to the operating part 9 of the electric toothbrush 7. An attachment protrudes out of the operating part 9 into the shaft 8 and can be operatively connected to the head 3 of the toothbrush element 1, so that movements generated in the operating part 9 can be transmitted to the head 3. The head 3 is preferably arranged in a rotationally movable manner on the shaft 8. When the electric toothbrush 7 is turned on, an electric motor arranged in the operating part 9 causes a movement, which is transferred to the head 3 and results in an oscillating movement of the head 3 and the bristles 2 attached to the head 3.

In an alternative embodiment, a device for generating a high-frequency sound with a frequency of 250 Hz to 1,800,00 Hz, for example, is provided in the operating part 9. In this case, sound is transmitted by means of the shaft 8 to the head 3 without requiring any mechanical components. The sound causes the bristles 2 to vibrate, which produces a cleaning effect.

The head 3 and the shaft 8 are each preferably made of a plastic material that can be injection molded. The bristles 2 are also made of plastic, such as polyamide (nylon). The toothbrush element 1 can therefore be manufactured inexpensively and is replaced at regular intervals with a new toothbrush element 1 every three months, for example.

The bristles 2 are arranged in a ring on the head 3, so that the bristles 2 surround a recess 4. The space between the bristles 2 formed by the recess 4 is free of bristles, so that the tooth or denture to be cleaned can protrude into the recess 4. For cleaning the tooth, the toothbrush element 1 is more or less placed on the tooth and/or denture to be cleaned, and the bristles 2 surround the tooth and clean it, including the base at the point of attachment to the gingiva.

FIG. 2 shows the toothbrush element illustrated in FIG. 1 in a sectional view from the side.

FIG. 3 shows an advantageous embodiment of the toothbrush element 1, wherein the toothbrush element 1 shown in the figure has a head 3, which is described in comparison with the heads shown in FIGS. 1 and 2 and is provided with an indentation 5. The indentation 5 is assigned to the recess 4. It is advantageous here that the tooth and/or denture to be cleaned can protrude through the recess 4 even into the indentation 5.

FIG. 4 shows an advantageous refinement of the embodiment according to FIG. 3, where the head 3 in this embodiment has a passage 6, which is assigned to the recess 4. The tooth and/or denture to be cleaned can therefore even protrude through the toothbrush element 1. In this embodiment, the head 3 is designed in the form of a ring, and the bristles 2, also arranged in a ring, are positioned on the head 3.

FIG. 5 shows the toothbrush element 1 according to FIG. 4 in a view from underneath.

FIG. 6 shows a sectional view of a toothbrush element 1 from the side, comprising a head 3 furnished with bristles 2, wherein the bristles 2 surround a recess 4. In this embodiment, the bristles 2 are inclined toward one another, so that the bristles 2 are arranged in a conical shape, wherein the diameter at the base of the bristles 2 is larger than that at the free ends of the bristles 2. In this embodiment, the pressure of the bristles 2 against the tooth and/or denture to be cleaned is improved, so that the cleaning effect is also improved.

In the embodiment shown in FIG. 6, the head 3 has a passage 6. However, it is also conceivable for the bristle arrangement shown in FIG. 6 to be provided on a head 3 equipped with an indentation 5 according to FIG. 3 or an embodiment of a head 3 according to FIG. 2.

FIG. 7 shows another advantageous embodiment of a toothbrush element 1, wherein the bristles 2 are curved in this embodiment, the free ends of the bristles facing one another. Again in this embodiment, there is increased contact pressure of the bristles 2 at their free ends against the tooth and/or denture to be cleaned.

FIG. 8 shows an embodiment of a toothbrush element 1, in which the bristles 2 are kinked, so that a first section of the bristles 2 has a different angle of attack relative to the vertical in the region of the base 2 toward the head 3, i.e., the angle is different from that of a second section of the bristles 2 in the region of their free ends.

With the toothbrush elements 1 shown in FIGS. 5 to 7, it has proven to be particularly advantageous when the free ends of the bristles are arranged at an angle between 20° and 60°, in particular preferably between 35° and 50° to the vertical and in the direction of the recess 4.

FIG. 9 shows an alternative embodiment of a toothbrush element 1, in which the head 3 is designed in the form of a partial ring circle. The protrusion 6 on the side facing away from the shaft 8 therefore protrudes through the head 3, which thus results in a lateral opening. It is therefore possible for the toothbrush element 1 to also be guided up to the tooth or the implant to be cleaned. In this embodiment, the passage 6 and the head 3 may also be designed to be oval.

FIG. 10 shows an electric toothbrush 7, comprising an operating part 9, which includes a battery and an electric motor. As an alternative to an electric motor, the operating part may also have a sound source for generating a high-frequency sound. The operating part 9 is designed so that the shaft 8 of the toothbrush element 1 can be attached to the operating part 9, wherein the rotational movements and/or sound waves generated in the operating part 9 are transmitted to the head 3 and thus to the bristles 2 via the shaft 8. The head 3 is arranged so that it is rotationally movable on the shaft 8 whenever rotational movements are generated in the operating part 9.

What is claimed is:

1. A toothbrush element, comprising a head furnished with bristles, characterized in that the bristles are arranged in a ring on the head, so that the bristles surround a recess.

2. The toothbrush element according to claim 1, wherein the head is furnished with an indentation, which is assigned to the recess.

3. The toothbrush element according to claim 1, wherein the head has a passage in the region of the recess.

4. The toothbrush element according to claim 1, wherein the bristles are inclined toward one another.

5. The toothbrush element according to claim 1, wherein the bristles are arranged at an inclination on the head.

6. The toothbrush element according to claim 1, wherein the bristles are curved and/or kinked.

7. The toothbrush element according to claim 1, wherein the recess and/or the passage is/are designed to be circular or oval.

8. The toothbrush element according to claim 1, wherein the head is designed in the form of a partial ring circle.

9. The toothbrush element according claim 1, wherein the toothbrush element is designed as an attachment for an electric toothbrush.

10. An electric toothbrush, comprising an operating part with a handle and a toothbrush element according to claim 1.
